(19) United States
(12) Patent Application Publication
(10) Pub. No.: US 2005/0080931 A1
(43) Pub. Date: Apr. 14, 2005

(54) Access networks

(76) Inventors: William Geoffrey Hardy, Binley Woods (GB); Vittoriano Grandi, Genova (IT)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/472,667

(22) PCT Filed: Mar. 11, 2002
(86) PCT No.: PCT/GB02/01091

(30) Foreign Application Priority Data
Mar. 20, 2001 (GB) 0106919.4

(51) Int. Cl. G06F 15/16; G06F 15/177

(52) U.S. Cl. 709/249; 709/222

(57) ABSTRACT

An access network is built using Ethernet or IEEE 802.3 technology. The network comprises a plurality of terminals, a hierarchy of concentrator stages and a DHCP server. On startup of the terminals, DHCP discover messages are sent to the server which include the terminals' MAC addresses. These addresses are cached at the concentrators against the ports on which they are received. Thus, unknown MAC addresses are only sent upstream. To avoid the network being flooded with broadcast messages, any time a client PC uses ARP to find the MAC address of any other client, the central server provides a proxy ARP function.

This invention relates to access networks for delivering data from telecommunications exchanges to customer premises.

Traditionally, telecommunications service providers have been required to supply voice communications to customers. More recently a variety of IP services have become available such as voice over IP, video, Internet access etc. This has caused a reevaluation of how access networks are designed.

Many businesses which are served by telecommunications companies use computer networks based on Ethernet or IEEE 802.3 standards. We have appreciated that it would be desirable to build an access network based on these standards.

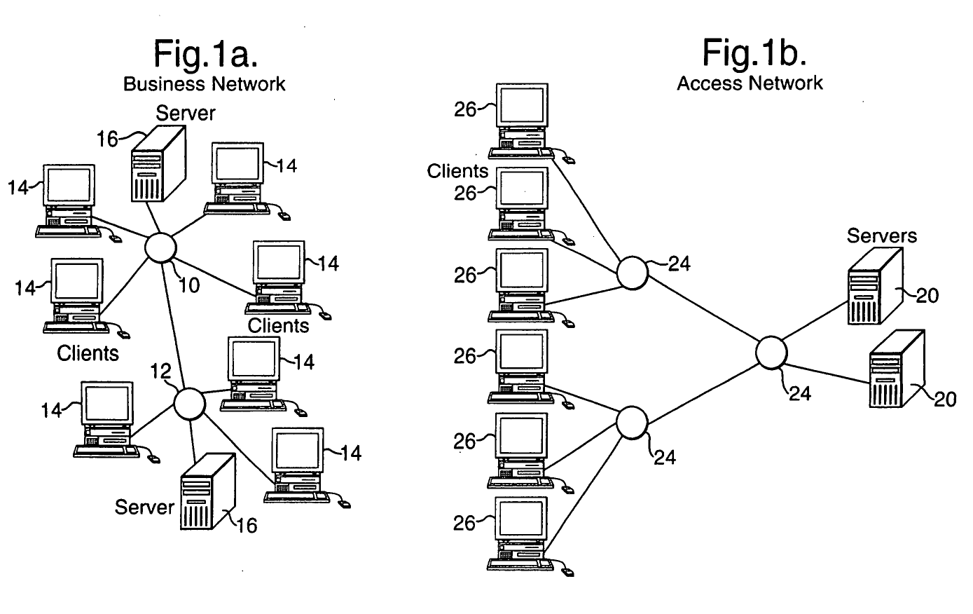

We have also appreciated that such a solution would need to overcome a number of different problems caused by the differences in characteristics between access networks and ethernet/IEEE 802.3 networks. FIGS. 1a) and 1b) illustrate, respectively, typical ethernet/IEEE 802.3 and access networks. The former, used in a business environment, operates with a fairly random flow of traffic around the network between the various nodes. In the simple example shown, there are two nodes 10, 12 to each of which are connected a number of clients 14 and a server 16, the nodes being interconnected. The random traffic may be between the clients and the servers and will be spread throughout the network. The access network of FIG. 1b) comprises a number of servers 20 connected to a head end concentrator node 22 which is connected to a pair of further concentrator nodes 24, each of which is connected to a number of clients 26. Nearly all the traffic will flow from the clients to the head end node which is the connection point to the service network and vice versa.

The lengths between nodes in a business network are typically short. As a result, it is relatively cheap to install high bandwidth links. By contrast, in an access network, clients are spread over a geographically wide area and many of the links will use low bandwidth technologies such as DSL or modem links. Moreover, an access network is typically many times larger than a business network.

Ethernet/IEEE802.3 switches rely on the use of broadcasts to find a host whose location is unknown. This is unacceptable in an access network, which is much larger than a business network as broadcast traffic would travel fruitlessly along all paths in the network using up a large amount of bandwidth in an environment in which bandwidth resources are sparse.

The aim of the present invention is to overcome the problems outlined above. Accordingly, there is provided

A method of routing data in an access network, the network comprising a server, at least one concentrator coupled to the server, and a plurality of terminals coupled to the concentrator, the method comprising: sending a unique address for each terminal from the terminal to the server via the concentrator, storing the unique terminal address at the concentrator; and routing future data addressed to a given terminal to the address for that terminal stored at the concentrator.

The invention also provides an access network, comprising a server, at least one concentrator coupled to the server, and a plurality of terminals coupled to the concentrator, wherein each of the terminal comprises means for sending a unique address for that terminal to the server via the concentrator, and the concentrator includes a store for storing the unique terminal addresses, whereby the concentrator can route future data addressed to a given terminal to the address for that terminal stored in the store.

Embodiments of the invention have the advantage that by caching terminal addresses at the concentrators, there is no need to broadcast frames on all ports when a destination address is unknown as the situation will not arise. This makes it realisable to build access networks using Ethernet/IEEE 802.3 technology.

Preferably, the server is a DHCP server and the unique address is the terminal MAC address sent in a DHCP discover message.

Preferably, the concentrators store terminal addresses against the ports on which they were received.

Preferably, where the IP address of a terminal is known but the MAC address is not, an ARP request is sent to the server. As the server already knows all the MAC addresses it can either answer the ARP request itself or send it as a unicast to the appropriate destination. This has the advantage of avoiding broadcasting ARP requests throughout the network which can flood the network and degrade performance.

An embodiment of the invention will now be described, by way of example, and with reference to the accompanying drawings in which:

FIGS. 1a) and 1b), referred to previously, show examples of typical business networks and access networks, respectively; and

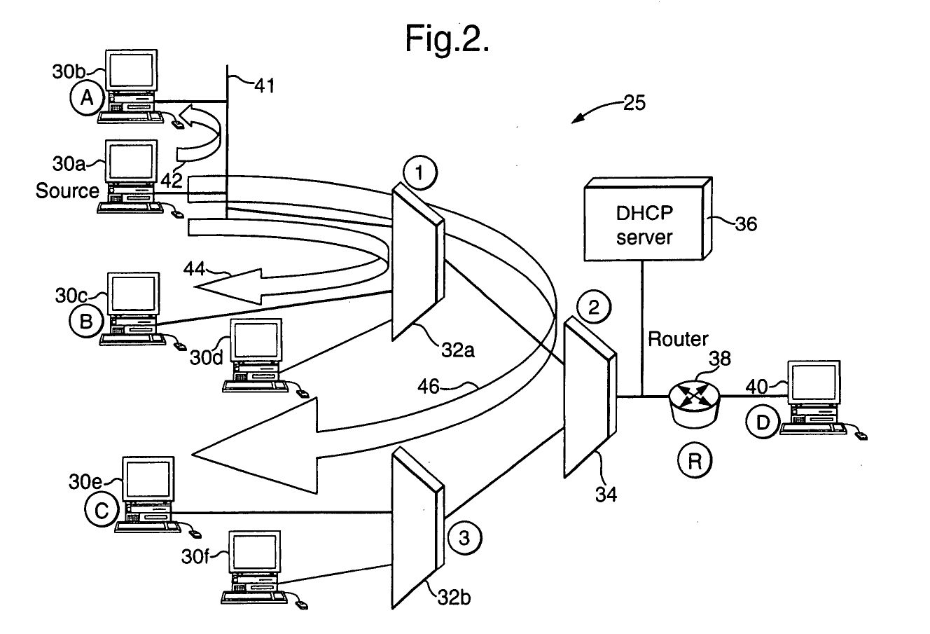

FIG. 2 shows an access network embodying the present invention.

In the access network 25 of FIG. 2, a nominal number of PCs 30a-30f are connected to one of two concentrators 32a, 32b. Although PCs are used in this example, it will be appreciated that other ethernet devices could be used. The two concentrators are connected to a further concentrator 34 which is attached to a DHCP (Dynamic Host Configuration Protocol) server 36 and a router 38. The router is connected to a further PC 40 although this may not be directly connected. PCs 30a, 30b are on the same local area network (LAN).

When a source PC, for example PC 30a, wants to send an ethernet frame to another PC, the most desirable frame routing will depend on the position of the destination PC in the network.

To communicate with the PC 30b, which is on the same LAN 41, the routing will be over the LAN without the frame being sent to the access network at all. This is indicated by arrow 42 in FIG. 2. In practice, if the LAN uses an ethernet switch, the frame can be maintained within the LAN. However, if a simple ethernet hub is used instead, the frame will appear at concentrator 32a). The frame should not be propagated any further throughout the access network.

Where the source PC 30a wants to send a frame to PC 30c, the ideal route is to send the frame to the port on concentrator 32a to which PC 30c is connected but to no other port. Thus, the message is to be a unicast. This route is shown by an arrow 44.

Where the frame is to be sent from the source PC 30a to PC 30e, the most desirable route is via the first concentrator 32a, then to the second concentrator 34 and then to the third concentrator 32b) which routes it to the port to which PC 30e is connected. None of the concentrators should route frames to any other port.

Finally, where the source PC wants to send frames to PC 40, the frames have to exit the local network and are sent to the first concentrator 32a, to the second concentrator 34 and then to PC 40 via one or more routers 38 using an IP transmission protocol.

Thus, in each of the routing scenarios illustrated, if the destination address of the PC is not known it is not acceptable to broadcast to all other PCs. The routing environment is unicast. Frame transmission rules for upstream and downstream transmission for each of the concentration points may be summarised as follows:

Upstream Frames

If the destination MAC (Media Access Control) address of the frame is known to be downstream of any concentrator output port, send the frame to that port, unless the frame was received on that port, and no other; else send the frame upstream to the next concentration point.

Downstream Frames

If the destination MAC address of the frame is known to be downstream of any output port, then send the frame to that port and no other, else discard the frame.

A conventional ethernet switch could obey both the upstream and downstream conditions where the destination address is known, but would not obey the rules if the address was not known, resorting to a network broadcast asking the destination to identify itself. This problem is solved by maintaining a record of the identities of all PCs on the network at an upstream location. In an access network, it is essential that each concentration stage knows all the MAC addresses of the PCs that are downstream of its ports. Unlike a conventional LAN, a client cannot be spoken to until it has spoken itself.

This is achieved in the FIG. 2 embodiment by using the DHCP requests to the DHCP server 36 to create the association between terminal and address within the concentrator. On start up of the PC, as it boots up, the PC will send a DHCP discover message containing its MAC address. These MAC addresses are received at the concentrators, cached and stored against the port from which they have been received before being sent on to the DHCP server.

Thus, the ethernet concentrators each has an address table which stores a record of its various port numbers and the address of each PC connected to those ports. Concentrators will often age out entries in address tables. In order to prevent this from becoming a problem, the DHCP lease timeout can be set to a time less than the concentrator age timeout. Thus, clients that are active on the Internet will refresh their MAC addresses when they renew their DHCP leases.

The following section considers how the MAC address of a client can be determined if the IP address for the client is already known. In this situation an ARP (Address Resolution Protocol) message is conventionally sent. This protocol uses a broadcast message to identify itself. In an access network, this behaviour is undesirable.

If used in the conventional manner in an access network the network would be flooded with broadcast messages as any time a client PC used ARP to find the MAC address of any other client, a broadcast would be sent to all other clients. This would degrade performance in a limited bandwidth network such as an access network.

This problem may be eliminated by using an ARP proxy function within the DHCP server or Head End Concentrator 34. The concentrators forward all broadcasts upstream, rather than sending them back both upstream and downstream to all connected ports. The ARP proxy function, which has a stored list of the MAC addresses of all clients, will then respond on behalf of the client.

Alternatively, the ARP proxy function can receive the ARP request, look up the MAC address for the intended recipient and forward the ARP request to that recipient. This is a unicast rather than a broadcast downstream. The client then responds to the original requester in the normal manner. This method will only work if the client's software will accept a unicast ARP request.

Thus, in the system and method described, broadcast frames are only sent upstream and never transmitted downstream.

It will be appreciated from the foregoing description that the embodiment enables an ethernet/IEEE 802.3 network to be used in an access network. This is advantageous as many of the customers connected to the access network will already be using this type of network.

Various modifications to the embodiment described are possible within the scope of the invention and will occur to those skilled in the art. The invention is defined by the following claims:

1-24. (canceled)

25. A method of routing data in an access network including a server, at least one concentrator coupled to the server via an upstream port of the at least one concentrator, and a plurality of terminals coupled to the at least one concentrator via at least one downstream port of the concentrator, the method comprising the steps of:
a) sending a unique terminal address for each terminal from the terminal to the server via the at least one concentrator;
b) storing the unique terminal address at the at least one concentrator;
c) routing future data addressed to a given destination terminal according to the unique terminal address for that terminal stored at the at least one concentrator; and
d) if the destination of the data is connected via a downstream port, sending the data to that port, and no other.

26. The method according to claim 25, including the step of, if the data is received via a downstream port and the destination of the data is not connected via a downstream port, sending the data to the upstream port.

27. The method according to claim 25, including the step of, if the data is received via the upstream port and the destination of the data is not connected via a downstream port, discarding the data.

28. The method according to claim 25, wherein broadcast data are only sent upstream and never downstream.

29. The method according to claim 25, wherein the step of sending the unique terminal address comprises sending a media access control (MAC) address of each terminal.

30. The method according to claim 25, wherein the server is a dynamic host configuration protocol (DHCP) server, and the step of sending the unique terminal address to the server comprises sending a DHCP discover message to the server, the DHCP discover message containing the unique terminal address.

31. The method according to claim 25, wherein the step of storing the unique terminal addresses at the at least one concentrator comprises storing the terminal addresses against the port of the at least one concentrator from which they are received.

32. The method according to claim 25, wherein each of the terminals, the server and the at least one concentrator has a timeout period for stored entries, and comprising the step of setting the timeout of the terminals addresses to a timeout shorter than that of a store for the at least one concentrator or the server.

33. The method according to claim 25, including the steps of sending an address resolution protocol (ARP) broadcast message from a terminal to the at least one concentrator, and routing the ARP broadcast message to the server.

34. The method according to claim 33, wherein the server sends out the unique terminal address of a terminal identified in an ARP request to a requesting terminal.

35. The method according to claim 33, wherein the server forwards an ARP request as a unicast message to the unique terminal address of the terminal identified in the ARP request.

36. An access network, comprising:
a) a server;
b) at least one concentrator coupled to the server via an upstream port of the at least one concentrator;
c) a plurality of terminals coupled to the at least one concentrator via at least one downstream port of the at least one concentrator;
d) each of the terminals including means for sending a unique terminal address for that terminal to the server via the at least one concentrator; and
e) the at least one concentrator including a store for storing the unique terminal addresses, and including means for sending data for which the destination is connected via a downstream port to that port, and no other.

37. The access network according to claim 36, wherein the at least one concentrator includes means for sending data received via a downstream port, and for which the destination is not connected via a downstream port, to the upstream port.

38. The access network according to claim 36, wherein the at least one concentrator includes means for discarding data received via the upstream port and for which the destination is not connected via a downstream port.

39. The access network according to claim 36, wherein the at least one concentrator includes means for sending broadcast data upstream and never downstream.

40. The access network according to claim 36, wherein the unique terminal address sending means at each terminal includes means for sending a media access control (MAC) address of that terminal.

41. The access network according to claim 36, wherein the server is a dynamic host configuration protocol (DHCP) server, and the means for sending the unique terminal address to the DHCP server at each terminal includes means for sending a DHCP discover message to the DHCP server, the DHCP discover message containing the unique terminal address.

42. The access network according to claim 36, wherein the concentrator store stores the unique terminal addresses against the ports on which they were received from the terminals.

43. The access network according to claim 36, wherein each of the terminals, the server and the concentrator store includes a timeout for stored entries, and wherein the timeout of the terminals is set to a time shorter than the timeout of the server or the concentrator store.

44. The access network according to claim 36, wherein the terminals include means for broadcasting an address resolution protocol (ARP) message to the server via the at least one concentrator.

45. The access network according to claim 44, wherein the server comprises means for sending out the unique terminal address of the terminal identified in an ARP request to a requesting terminal.

46. The access network according to claim 44, wherein the server includes means for routing an ARP request to the terminal identified in the ARP request.

47. The access network according to claim 36, wherein the network is an Ethernet or IEEE 802.3 network.

48. The access network according to claim 36, wherein the network comprises a plurality of concentrators arranged between the server and the terminals, a first concentrator being connected between the server and further concentrators, and the further concentrators being connected either to the terminals or indirectly to the terminals via one or more further concentrators.
